(19) United States
(12) Patent Application Publication
(10) Pub. No.: US 2005/0162008 A1
(43) Pub. Date: Jul. 28, 2005

(54) Arrangement for an electrohydraulic brake system and method for controlling electrohydraulic brake system and tandem master brake cylinder

(75) Inventors: Boris Bickel, Stuttgart (DE); Ekkehard Niemann, Hanau (DE)

Correspondence Address: CROWELL & MORING LLP;INTELLECTUAL PROPERTY GROUP, P.O. BOX 14300, WASHINGTON, DC, 20044-4300, US

(73) Assignee: Daimler Chrysler AG, Stuttgart (DE)

(21) Appl. No.: 10/497,609

(22) PCT Filed: Oct. 16, 2002
(86) PCT No.: PCT/EP02/11542

(30) Foreign Application Priority Data
Dec. 5, 2001 (DE) 10159788.6

(51) Int. Cl. B60T 8/34

(52) U.S. Cl. 303/113.4

(57) ABSTRACT

A method and an arrangement are provided for the return of brake fluid from a pedal travel simulator into the auxiliary brake circuit of an electrohydraulic brake system, and to an electrohydraulic brake system and a tandem master brake cylinder. For this purpose, in an emergency, the return line of the pedal travel simulator, which is connected to the brake fluid reservoir during normal operation, is separated from the unpressurized brake fluid reservoir and instead connected to the delivery side of the electrohydraulic pressure supply system or at least to the pressure accumulator of the electrohydraulic system.

### BACKGROUND OF THE INVENTION

The present invention relates to a method and an arrangement for the return of brake fluid from a pedal travel simulator into the auxiliary brake circuit of an electrohydraulic brake system, and to an electrohydraulic brake system and a tandem master brake cylinder.

An electrohydraulic brake system having a pedal travel simulator is described in detail, for example, in WO 99/29548. In conventional brake systems for passenger vehicles, the brake force applied by the driver is transmitted mechanically by lever transmission of the brake pedal to a brake booster and then on in an intensified manner to the master brake cylinder. The pressure which is produced brings about the desired braking action at the individual wheel brakes. In the case of an electrohydraulic brake, this purely mechanically hydraulic chain of action is interrupted and replaced by sensors, a control unit and a pressure supply. Normal braking has no mechanical or hydraulic connection between the brake pedal and the wheel brake.

An electrohydraulic brake comprises an actuating unit having a brake pedal, master brake cylinder and pedal travel simulator, a hydraulic control unit, sensors (for example, travel sensors, pressure sensors, wheel speed sensors), electric control units for the hydraulic control unit, a pressure supply, control and pressure lines and hydraulic valves.

The basic manner of operation of an electrohydraulic brake can be summarized as follows. Two different sensors namely a sensor on the actuating unit for the pedal travel and a pressure sensor on the hydraulic control unit, detect the brake application intention and transmit it to the control unit. The functions of brake boosting, antilock system (ABS), anti-slip control (ASC) and electronic stability program (ESP) are also integrated in this control unit with software. The other ABS, ASC and ESP sensors supply the control unit with data about the driving state, such as speed or cornering, and about the state of movement of the individual wheels. The software of the control unit determines from these data signals for the hydraulic control unit, which converts said signals into brake pressures for the individual wheels. An electrically driven hydraulic pump with a high-pressure accumulator and pressure monitoring forms the pressure supply.

In the undisturbed state of the electrohydraulic brake system, i.e. during normal operation, the brake pedal acts on the master brake cylinder and the pedal travel simulator arranged downstream thereof. The normal braking takes place with the activation of the hydraulic control unit. If, during the braking, a defect occurs in the brake system, for safety reasons a switch is made into a state in which a hydraulic connection is produced between the actuating unit and the wheel brakes.

In the event of a defect in known electrohydraulic brake systems, the pressure supply of the electrohydraulic brake system is separated by cut valves from the wheel brakes. The vehicle is then brought to a standstill manually by the driver. A stock of pressure which may possibly still be present in the pressure supply of the electrohydraulic brake system is not used for the auxiliary braking.

A further state which is capable of improvement occurs if, in the known electrohydraulic brake systems, the electrohydraulic component fails during a brake process which has already been initiated, and a switch has to be made to the auxiliary brake circuit. This is because, in this case, the brake pedal has already been depressed during normal operation and the brake fluid has already been conveyed for the most part from the master brake cylinder into the pedal travel simulator. However, the brake fluid in the pedal travel simulator is no longer available for the auxiliary braking. Even if the brake fluid still situated in the master brake cylinder is sufficient in order to be able to carry out an auxiliary braking, which is always ensured owing to structural measures, then the pedal travel is nevertheless considerably reduced during an auxiliary braking. This leads to a deterioration in the ergonomic ratios of forces.

### SUMMARY OF THE INVENTION

An object according to the present invention is to improve the mechanically hydraulic auxiliary braking properties of known electrohydraulic brake systems.

According to the invention, this object has been achieved by providing for a return of the brake fluid from the pedal travel simulator into the auxiliary brake circuit. For this purpose, in an emergency, the return line of the pedal travel simulator, which is connected to the brake fluid reservoir during normal operation, is separated from the unpressurized brake fluid reservoir and instead connected to the delivery side of the electrohydraulic pressure supply system or at least to the pressure accumulator of the electrohydraulic system.

Among the principal advantages are the following. In an emergency, if the electrohydraulic component of the brake system fails, the residual pressure of the pressure accumulator is used to additionally provide the brake fluid, which has been fed from the master brake cylinder into the pedal travel simulator, for an auxiliary braking. The volumetric return of the brake fluid takes place from the pedal travel simulator back into the master brake cylinder and the auxiliary brake circuit connected thereto. The return volume is therefore available for the auxiliary braking and reduces the pedal travel. A release of the brake pedal, and therefore an interruption in the braking manoeuvre in order to permit brake fluid to continue flowing from the reservoir into the master brake cylinder, is not necessary with the volumetric return according to the invention. The braking manoeuvre can be carried out to the end without interruption.

If the electrohydraulic component of the brake system fails when the brake pedal is already actuated and the brake fluid reservoir is therefore separated from the master brake cylinder, the residual pressure of the pressure accumulator supports the auxiliary braking.

The coupling of the return line of the pedal travel simulator to the delivery side of the pressure supply also, however, affords advantages during normal operation of the electrohydraulic brake system. For this purpose, the return line of the pedal travel simulator is coupled via a parallel circuit both to the delivery side and also to the intake side of the pressure supply. In each branch of the parallel coupling there is a 2/2-way hydraulic valve with two possible positions and with two hydraulic connections. Clocking of the second 2/2-way hydraulic valve in the intake branch of the coupling circuit enables the resistance of the pedal travel simulator to the actuation of the brake pedal to be set in a specific manner by a pressure characteristic curve contained in the software of the electronic control unit of the brake system. Different linear or nonlinear pedal-travel/pedal-force characteristic curves can advantageously be set in a very elegant manner and the desired nonlinear pedal-travel/brake-pressure inter-relationships can thus be simulated.

No electric auxiliary control units of any type are arranged in the auxiliary brake circuit. The auxiliary brake circuit therefore remains fully operational even if the electric power supply in the motor vehicle fails.

The brake pedal acts on the master brake cylinder both during normal braking and during auxiliary braking of the electrohydraulic brake system. The pedal travel is therefore in principle virtually identical for normal operation and also for auxiliary operation, and the driver does not have to adjust to pedal travels which have suddenly changed. The invention reduces the pedal travel during the auxiliary braking.

### BRIEF DESCRIPTION OF THE DRAWINGS

Other objects, advantages and novel features of the present invention will become apparent from the following detailed description of the invention when considered in conjunction with the accompanying drawings.

FIG. 1 is a block circuit diagram of an electrohydraulic brake system with pressurized resetting of the pedal travel simulator and return of the brake fluid into the auxiliary brake circuit, and

FIG. 2 is a cross-sectional view of a tandem master brake cylinder with an integrated, mechanically actuable valve, suitable for the electrohydraulic brake system according to the invention.

### DETAILED DESCRIPTION OF THE DRAWINGS

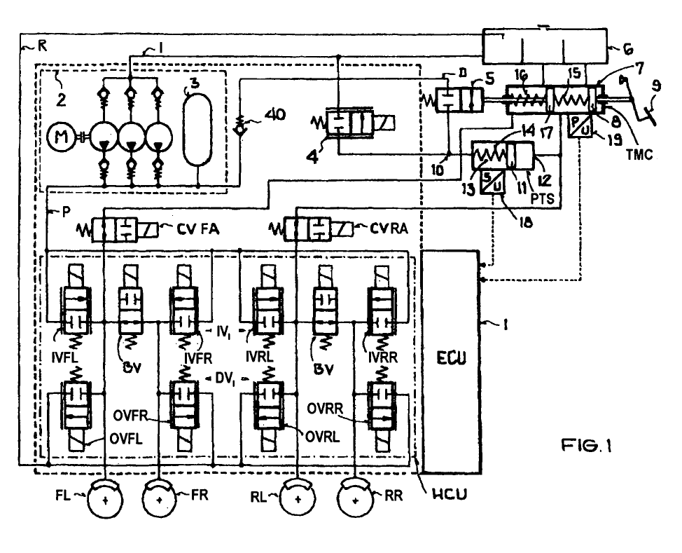

An electrohydraulic brake system according to FIG. 1 typically comprises the components (assumed to be known) of a pressure supply 2, of a control unit ECU (electronic control unit), of a hydraulic control unit HCU (hydraulic control unit) and of an actuating unit, including brake pedal 9, tandem master brake cylinder TMC and pedal travel simulator PTS.

During normal braking, the hydraulic control unit HCU is separated from the tandem master brake cylinder by cut valves CVFA (cut valve front axle) and CVRA (cut valve rear axle). The hydraulic control unit typically contains a plurality of 2/2-way hydraulic solenoid valves with in each case two setting possibilities and two hydraulic connections. For safety reasons and in accordance with legal regulations, there have to be at least two separate brake circuits in a motor vehicle for the driving brake. In the simplified exemplary embodiment shown, these are the two brake circuits for the front axle and for the rear axle of the vehicle. The brake circuit for the front axle is formed from an inlet valve at the front on the left IVfl and an outlet valve at the front on the left OVfl and the wheel brake at the front on the left FL, and also an inlet valve at the front on the right IVfr, an outlet valve at the front on the right OVfr and the wheel brake at the front on the right FR. A balance valve BV between the two inlet valves can ensure that the pressure between the left and right wheel brakes is balanced.

The same arrangement of solenoid valves is found once again in the hydraulic control unit for the rear axle. The brake circuit for the rear axle comprises an inlet valve at the rear on the left Ivrl, an outlet valve at the rear on the left OVrl and the wheel brake at the rear on the left RL, and also an inlet valve IVrr at the rear on the right, an outlet valve OVrr at the rear on the right and the wheel brake at the rear on the right RR. Again, a balance valve BV to ensure that the pressure between the left and right vehicle sides is balanced is also connected between the left and right inlet valves. All of the valves are designed as electrically actuable, activatable solenoid valves with automatic resetting and are activated by the control unit ECU of the electrohydraulic brake. The inlet valves and outlet valves of the hydraulic control unit are designed as proportional valves, because the brake pressure can be fed in better into the wheel brakes using proportional valves. The balance valves, which are situated in each case between the left wheel brake and right wheel brake, permit, depending on what the driving situation requires, either the pressure to be balanced between the left and right wheel brakes or, in the case of ABS, ASC, ESP applications, an individual braking of the vehicle wheels by separation of the left and right wheel brakes.

The pressure supply 2 of the hydraulic control unit comprises a driven hydraulic pump, for example a three-piston pump, which is connected by an intake line I to the brake fluid reservoir 6 and the delivery line D of which is connected to a pressure accumulator 3 and the hydraulic control unit. The inlet valves of the hydraulic control unit are supplied with pressurized brake fluid by the pressure supply. The outlet valves of the hydraulic control unit reduce the brake pressure again when they are opened. The outlet valves are therefore connected via a return line R to the brake fluid reservoir 6 into which the brake fluid flowing away out of the outlet valves is fed back.

During normal braking of the electrohydraulic brake system, the two brake circuits for the front axle and rear axle are separated from the tandem master brake cylinder by the two cut valves CVFA, CVRA. Upon actuation of the brake pedal, the brake fluid is fed out of one of the pressure chambers of the tandem master brake cylinder into a pedal travel simulator, which is generally designed as a hydraulically actuable spring-loaded pressure cylinder. By forcing the brake fluid out of the master brake cylinder into the hydraulic cylinder of the pedal travel simulator, the driver carries out work counter to the spring force of the pedal travel simulator. Via the piston travel of the pedal travel simulator and the pressure exerted by the driver, the driver's brake application intention is determined by travel and pressure sensors (not illustrated) on the pedal travel simulator and on the hydraulic control unit and is converted in the control unit by software into a braking manoeuvre by activating the hydraulic control unit.

In the event of the power supply in the motor vehicle becoming defective or failing, the brake system passes into a state using a purely mechanically hydraulic auxiliary brake circuit. For this purpose, the inlet valves of the hydraulic control unit separate the pressure supply from the brake lines of the wheel brakes. The two cut valves CVFA, CVRA connect the two pressure chambers of the tandem master brake cylinder to the two brake circuits of the motor vehicle. This enables the vehicle to remain capable of braking manually, by actuation of the brake pedal 9, although without power assistance.

The operation and the connection of the various valves previously described in the various operating modes of the brake control are adequately known from mechanically hydraulic two-circuit brake systems, ABS, ASC and ESP brake systems which have already been discussed, and do not need to be discussed here in detail. For the sake of completeness, the basic aspects have been dealt with again in brief in terms of the application of the invention and for understanding the invention.

The present invention resides in the hydraulic coupling of the tandem master brake cylinder and pedal travel simulator to the pressure supply of the electrohydraulic brake system. For this purpose, the pressure line P of the pressure supply is connected by two series-connected 2/2-way hydraulic valves to the intake line of the pressure supply I or to the return line R to the brake fluid reservoir. The first valve, as seen from the delivery side, is, from its function and action, a pressurization valve 5 and the valve following in series is, from its function and action, a pressure relief valve 4. Pressurization valve 5 and pressure relief valve 4 are in each case automatically resetting hydraulic valves. The pressure relief valve is a solenoid valve which can be activated and actuated by the control unit ECU of the brake system. In principle, the pressurization valve 5 may also be designed as an electric solenoid valve 7 which is activated by the control unit of the brake system. In the embodiment shown in FIG. 1, the pressurization valve 5 is advantageously a hydraulic valve which can be actuated mechanically and is actuated by the master brake cylinder TMC via a mechanical operative connection. A direct mechanical actuation of the pressurization valve 5 by the master brake cylinder, and therefore indirectly by the brake pedal 9, has the advantage of enabling the valve to be reliably actuated even if the electric power supply completely fails. The pressurization valve and the pressure relief valve are connected to a hydraulic line which, for its part, is connected via a three-way branch 10 to the hydraulic return line of the pedal travel simulator. The pedal travel simulator PTS is designed as a hydraulic cylinder with a piston 11 which divides the cylinder into two chambers, into an intake-side chamber 12 and into a return-side chamber 13. The intake-side chamber of the pedal travel simulator is hydraulically connected to the primary pressure chamber of the master brake cylinder TMC and is charged with pressure when the brake pedal is actuated.

The functional interaction between the master brake cylinder TMC, pedal travel simulator PTS, pressure supply and pressurization valve 5 and also pressure relief valve 4 is as follows. During normal braking of the brake system, i.e. in a defect-free state of the electrohydraulic brake system, the pressurization valve 5 remains permanently in its separating position. The pressure line of the pressure supply is therefore separated in normal operation from the return-side chamber of the pedal travel simulator PTS.

In an advantageous variant of the present invention in FIG. 1, the pedal travel simulator PTS is a hydraulic spring-loaded cylinder. In that case, the return-side chamber of the pedal travel simulator is designed as a spring chamber and contains a compression spring 14 which pushes the piston in the unloaded state, i.e. when the brake pedal is not actuated, into its starting state on the intake side.

During normal braking, the two cut valves CVFA, CVRA are also in their closed position, so that the tandem master break cylinder TMC is separated from the hydraulic control unit. This has the effect of closing off the hydraulic line of the secondary-side pressure chamber 16 of the tandem master brake cylinder, so that the enclosed brake fluid prevents a movement of the secondary piston 17 in the tandem master brake cylinder. Similarly, during normal braking, the hydraulic line between the primary-side pressure chamber 15 and the hydraulic control unit is interrupted. However, the pedal itself is not blocked as a result because, when the brake pedal is actuated, the hydraulic fluid is pressed by the piston, which is actuated by the brake pedal, into the pedal travel simulator.

In the normal state, the pressure relief valve 4 in the return line of the pedal travel simulator is open, so that the piston 11 of the pedal travel simulator can yield in this state to actuation of the brake pedal as a function of the opening of the pressure relief valve. When the brake pedal is not actuated, the pressure relief valve (4) may be open or closed. However, measures have to be taken to ensure that, when the brake pedal is actuated, the pressure relief valve (4) is at least partially open before the cut valves close.

This gives rise to one of the advantages according to the present invention for the normal operation of the electrohydraulic brake system. Since the resistance of the piston movement depends not only on the spring force and therefore the restoring force of the pedal travel simulator, but also on the opening of the pressure relief valve, linear or nonlinear pedal-travel/pedal-force interrelationships can be set and simulated by specific opening and closing of the pressure relief valve 4. For this purpose, the piston travel in the pedal travel simulator is measured, for example, with a travel sensor 18 and the desired brake pressure is measured with a pressure sensor 19 on that brake chamber 15 of the tandem master brake cylinder which faces the pedal. After conversion of the measured values into a voltage signal U, the travel sensor and pressure sensor pass on their measured values to the control unit ECU. In the control unit, the measured values for the desired brake pressure and the piston travel in the pedal travel simulator are converted by software into control commands for the valves of the hydraulic control unit and therefore for the actual brake pressure present at the wheel brakes and, according to the invention, also into control commands for the opening and closing of the pressure relief valve 4. In this case, the piston travel is a measure of the pedal travel and the pressure in the primary pressure chamber of the tandem master brake cylinder is a measure of the pedal force which is to be set.

From the pedal travel and pedal force, software in the control unit (ECU) determines the brake application intention and the brake pressure which is to be set at the wheel brakes. Those valves of the brake system which are activated by the control unit are actuators in this case. In the control unit itself, the sensor/actuator interrelationships are kept in maps, so that, for each sensor record, an unambiguous actuator record and therefore an unambiguous activation of the brake system, or more precisely the valves of the brake system, is stored. In the case of the linear or nonlinear pedal-travel/pedal-force interrelationship which is desired according to the invention, the map for activating the pressure relief valves comprises a linear or nonlinear characteristic curve, in which the brake pressure rises super-proportionally and at best progressively or exponentially with the pedal travel. This is achieved by the degree of closing of the pressure relief valve increasing with increasing pedal travel. Such characteristic curves can be followed best in terms of control technology by proportional valves. The pressure relief valve is therefore expediently designed as a proportional valve.

In a simpler, less preferred embodiment, the pressure relief valve may also be a cut valve. In that case, the nonlinear pedal-travel/brake-pressure characteristic curve would have to be followed by clocking, i.e. rapid, time-controlled opening and closing of the cut valve. In a manner similar to a pulse-width control, the time intervals in which the pressure relief valve is closed would then have to increase, with increasing pedal travel, super-proportionally or at best progressively or exponentially as the pedal travel becomes greater. However, under some circumstances, this would result in a slight vibration of the brake pedal which might be perceived by a driver of a motor vehicle as being unpleasant.

The second main advantage of the present invention arises if, during braking, a defect in the electrohydraulic brake system occurs. In the event of a defect, all four inlet valves of the hydraulic control unit for the four wheel brakes are switched by the control unit into their closed state. If the control unit fails, the construction of the inlet valves means that if there is a failure of voltage to the drive of the valves, they pass automatically into the closed state. If there is a failure of voltage, the closed state is automatically taken up because of the resetting of the valves which is brought about by spring force. Closure of all of the inlet valves enables the pressure supply 2 to be decoupled from the brake circuits. At the same time, the cut valves CVFA, CVRA, with which the hydraulic control unit is decoupled from the tandem master brake cylinder in the normal state, open.

The construction of the cut valves means that, if activation is absent or if there is a failure of voltage to the setting element of the cut valves, the cut valves pass into the open position. If there is a failure of voltage, the open position is automatically taken up because of the resetting of the cut valves which is brought about by spring force. Likewise, at the same time as or earlier than the resetting of the cut valves and of the inlet valves, the pressure relief valve 4 in the return line of the pedal travel simulator is closed. This valve is also constructed so that, if there is a failure in the activation or if there is a failure in the voltage supply, the closed position is automatically taken up because of the spring-force resetting. These changes of the valve positions mean that the electrohydraulic brake system is now in the fallback level. The valve positions have activated the auxiliary brake circuit.

In the auxiliary brake circuit shown in FIG. 1, the primary pressure chamber 15 of the tandem master cylinder TMC is now connected by a hydraulic line via the open cut valve CVRA for the rear-axle brake circuit to the wheel brakes of the rear-axle brake circuit. The secondary, second pressure chamber 16 of the tandem master brake cylinder is now connected by a hydraulic line via the open cut valve CVFA for the front-axle brake circuit to the wheel brakes of the front-axle brake circuit. This makes it possible for the secondary piston 17 to move in the tandem master brake cylinder. In the auxiliary braking mode, the piston of the pedal travel simulator is now locked by closing the pressure relief valve 4 in the return line of the pedal travel simulator. When the brake pedal is actuated, brake fluid can therefore no longer flow into the pedal travel simulator. The brake pressure applied by the driver by pedal pressure is transmitted from the first, primary pressure chamber of the tandem master brake cylinder TMC by hydraulic lines to the wheel brakes of the rear axle. At the same time, when the brake pedal is actuated, the secondary piston 17 of the tandem master brake cylinder is actuated and the brake pressure in the secondary pressure chamber is transmitted by hydraulic lines to the wheel brakes of the front axle.

In contrast with known auxiliary brake circuits of electrohydraulic brake systems, in the case of the arrangement according to the invention, in addition the return-side chamber 13 of the pedal travel simulator PTS is hydraulically connected to the pressure supply 2 or at least to the pressure accumulator 3 of the pressure supply by a pressure line P. When the brake pedal 9 is actuated, the displacement of the secondary piston 17 in the tandem master brake cylinder TMC causes the pressurization valve 5, which is in mechanical operative connection with the secondary piston, e.g. via a piston rod, to be changed over from its closed state into the open state. This causes the pressure of the pressure supply 2 to be exerted via a pressure line P onto the return-side chamber 13 of the pedal travel simulator PTS. The pressure accumulator 3, at least, is connected via a pressure line to the return-side chamber 13 of the pedal travel simulator.

Because the pressure relief valve 4 is closed during auxiliary braking, when the brake pedal is actuated, opening of the pressurization valve 5 causes the pressure which is still in the pressure accumulator to be applied to the return-side chamber of the pedal travel simulator. If the piston 11 of the pedal travel simulator PTS should not be in its intake-side end position, it is moved by this return-side pressurization into its intake-side end position, even counter to a possible brake pressure, by foot-applied actuation of the brake pedal. The pressure in the pressure supply or in the pressure accumulator is generally greater than the brake pressure which is applied manually by a driver by actuating the brake pedal.

The foregoing brings about the following two different advantages of an electrohydraulic brake system formed with a valve arrangement according to the invention in the return line of the pedal travel simulator.

First brake fluid which has been fed from the tandem master brake cylinder into the pedal travel simulator is conveyed back again into the auxiliary brake circuit by this return-side pressurization of the pedal travel simulator. This gives rise to a volumetric return of the brake fluid situated in the pedal travel simulator either into the tandem master brake cylinder or into the brake cylinders of the wheel brakes of the connected auxiliary brake circuit. In the embodiment of FIG. 1, the auxiliary brake circuit for the rear wheels is connected to the pedal travel simulator. Of course, the auxiliary brake circuit for the front wheels or another combination of front wheels and rear wheels allowed in accordance with motor vehicle regulations as auxiliary brake circuit could also be connected to the pedal travel simulator.

If the electrohydraulic brake system with the brake pedal actuated and pressed should fail, the brake fluid volume, which has been fed from the tandem master brake cylinder into the pedal travel simulator where it would be unavailable for auxiliary braking, is fed by volumetric return back into the auxiliary brake circuit again, specifically when the brake pedal is actuated, without the braking operation being interrupted. In previously known electrohydraulic brake systems, the brake pedal had to be released in this case, so that the brake fluid can flow back from the pedal travel simulator into the auxiliary brake circuit. Following this, in the case of known systems, the piston of the pedal travel simulator is blocked. In a hazardous situation, in the case of auxiliary brakings using previously known electrohydraulic brake systems, under some circumstances a valuable length of the braking path is therefore wasted. The present invention considerably shortens the length of the braking path in the case of auxiliary braking and therefore increases the safety for all traffic participants.

Second, if the electrohydraulic brake system should fail when the brake pedal is not actuated, then with the measure according to the present invention of the return-side pressurization of the pedal travel simulator together with the closing of the pressure relief valve 4, the piston 11 of the pedal travel simulator is locked in the intake-side end position, so that when auxiliary braking is initiated, brake fluid cannot be conveyed from the tandem master brake cylinder into the pedal travel simulator. Possible leakage of the pressure relief valve 4 can be compensated for by the additional pressurization.

In a further embodiment of the present invention, a nonreturn valve 40 is preferably installed in the hydraulic connection between the pressure supply 2 and the three-way branch 10 to the pedal travel simulator, the nonreturn valve preventing a volumetric flow from the pedal travel simulator into the pressure supply. This prevents a volumetric feeding of brake fluid from the tandem master brake cylinder into the pressure chamber of the pedal travel simulator if there is insufficient residual pressure in the pressure supply or in the pressure accumulator. As an alternative, the nonreturn valve 40 and the pressurization valve 5 can be integrated in one component.

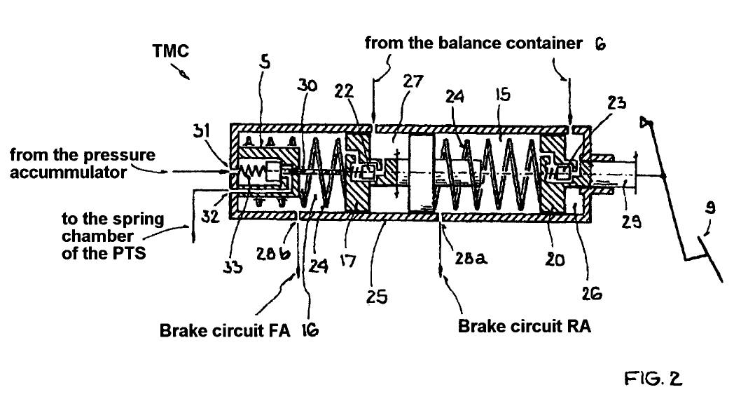

FIG. 2 is a schematic sectional view through a tandem master brake cylinder with an integrated, mechanically actuable additional valve which can be operated as a pressurization valve 5 for an electrohydraulic brake system according to the present invention. The tandem master brake cylinder TMC contains a primary piston 20 with a central valve 23 and a secondary piston 17 with a central valve 22 in a housing 25 in a manner known per se. The two pistons are arranged consecutively from the brake-pedal side in the cylindrical, pressure-tight housing in the specified sequence, beginning with the primary piston.

The pistons divide the housing, or more precisely the brake cylinder, into a total of four subspaces, namely a primary pressure-balancing space 26, a primary pressure chamber 15, a secondary pressure-balancing space 27 and a secondary pressure chamber 16. The two pressure-balancing spaces are connected in each case via balance bores to the balance container 6 of the brake system. The intermediate space between the primary piston and the secondary piston forms the primary pressure chamber 15 which is connected to the first brake circuit of the brake system via a hydraulic connection 28a.

The pressure space which is formed by the secondary piston 17 and the housing at that end of the brake cylinder which is remote from the pedal forms the secondary pressure chamber 16, which is connected to the second brake circuit of the brake system via a further hydraulic connection 28b. The pedal force from the brake pedal is transmitted to the primary piston by a piston rod 29.

In the unloaded state of the brake cylinder, the two central valves 22, 23 in the primary piston and in the secondary piston are open and permit a balancing of the pressure of the two pressure chambers with the balance container of the brake system. In the loaded state, i.e. when the brake pedal is actuated, the two central valves close and separate the two pressure chambers in each case from the pressure-balancing spaces and therefore from the balance container of the brake system. When the brake pedal is released, the secondary piston and primary piston are brought back again into their unloaded starting position by restoring springs 24. To this extent, tandem master brake cylinders are known from the prior art.

According to the present invention, a tandem master brake cylinder for use in the previously described, electrohydraulic brake system is now developed using an additional, mechanically actuable valve, to which an outer hydraulic line can be connected. For this purpose, an additional hydraulic valve 5 which is in mechanical operative connection with the secondary piston 17 is arranged on or in the secondary pressure chamber. In the embodiment shown in FIG. 2, the hydraulic valve 5 is arranged within the secondary pressure chamber 16 of the tandem master brake cylinder and is opened by a piston rod 30, which is connected to the secondary piston 17, when the secondary piston is actuated, so that then the two hydraulic connections 31, 32 of the additional hydraulic valve are connected to each other. If the secondary piston is relieved of load again, the additional hydraulic valve 5 closes again. The closing process of the hydraulic valve can be assisted in this case by a resetting spring 33 contained in the valve itself.

The tandem master brake cylinder with the additional hydraulic valve is particularly suitable in conjunction with an arrangement according to the invention for an electrohydraulic brake system. This is because the additional hydraulic valve of the tandem master brake cylinder can be used in the arrangement according to the invention as a pressurization valve 5. For this purpose, the one, outer hydraulic connection 31 of the additional hydraulic valve is connected to the pressure supply 2 or at least to the pressure accumulator 3 of an electrohydraulic brake system, and the second connection 32 of the additional hydraulic valve is connected to the return-side spring chamber 13 of the pedal travel simulator of an electrohydraulic brake system. As a result, the pressurization valve 5 and the tandem master brake cylinder TMC from the exemplary embodiment of FIG. 1 are advantageously combined in one component and are of single-piece design.

1-24. (canceled)

25. An arrangement for an electrohydraulic brake system, comprising a tandem master brake cylinder, a hydraulic cylinder configured as pedal travel simulator, one of a pressure supply or at least one pressure accumulator and two hydraulic valves, wherein
a primary pressure chamber of the tandem master brake cylinder is operatively connected to an intake-side chamber of the pedal travel simulator, and
a return-side chamber of the pedal travel simulator is operatively connected hydraulically via a three-way branch to a parallel circuit of two hydraulic lines which each contain a hydraulic valve.

26. The arrangement as claimed in claim 25, wherein one of the two hydraulic valves is a pressurization valve and the other of the two hydraulic valves is a pressure relief valve.

27. The arrangement as claimed in claim 26, wherein the pressurization valve is an electromechanical proportional valve.

28. The arrangement as claimed in claim 26, wherein the pressure relief valve is a proportional valve.

29. The arrangement as claimed in claim 26, wherein the pressurization valve is mechanically operatively connected with a secondary piston of the tandem master brake cylinder.

30. The arrangement as claimed in claim 29, wherein the pressurization valve and the tandem master brake cylinder are separate components.

31. The arrangement as claimed in claim 28, wherein the pressurization valve and the tandem master brake cylinder are a unitary component.

32. An electrohydraulic brake system, comprising a hydraulic control unit for at least two brake circuits, at least two cut valves, an electronic control unit, one pressure supply and at least one pressure accumulator, a plurality of sensors arranged to determine a brake application intention, and an actuating unit comprising a brake pedal, a tandem master brake cylinder and a pedal travel simulator, wherein a hydraulic return line of the pedal travel simulator is operatively connected via a three-way branch with a hydraulic line and, via a pressurization valve, to the pressure supply or to the at least one pressure accumulator and is connected with a hydraulic line, via a pressure relief valve, to an intake side of the pressure supply, a brake fluid reservoir or to a return line of the hydraulic control unit.

33. The electrohydraulic brake system as claimed in claim 32, wherein the pressure relief valve is operatively connected to the control unit.

34. The electrohydraulic brake system as claimed in claim 32, wherein the sensors are travel sensors or pressure sensors.

35. The electrohydraulic brake system as claimed in claim 32, wherein the sensors include a travel sensor arranged on the pedal travel simulator, on the brake pedal or on the tandem master brake cylinder, and a pressure sensor arranged on the tandem master brake cylinder, on the pedal travel simulator or on the hydraulic control unit,
the travel sensor and the pressure sensor being connectable to the control unit, and the brake application intention being determined from the signals of the travel sensor and of the pressure sensor in the control unit by software.

36. The electrohydraulic brake system as claimed in claim 35, wherein the pressure relief valve is configured to be activated as a function of the signals of the travel sensor or of the pressure sensor.

37. The electrohydraulic brake system as claimed in claim 36, wherein a degree of closing of the pressure relief valve increases super-proportionally or exponentially with increasing pedal travel of the brake pedal.

38. The electrohydraulic brake system as claimed in claim 32, wherein, in the event of one of the components of the brake system becoming defective or if the control unit fails, the pressure relief valve is configured to be moved to the closed position.

39. The electrohydraulic brake system as claimed in claim 32, wherein, in the event of one of the components of the brake system becoming defective or if the control unit fails, the pressurization valve is configured to be moved to the opened position upon actuation of the brake pedal.

40. The electrohydraulic brake system as claimed in claim 39, wherein, in the event of one of the components of the brake system becoming defective or if the control unit fails, the pressure relief valve is configured to be moved to the closed position.

41. The electrohydraulic brake system as claimed in claim 32, wherein the tandem master brake cylinder and the pressurization valve are separate components.

42. The electrohydraulic brake system as claimed in claim 32, wherein the tandem master brake cylinder and the pressurization valve are a unitary component.

43. A tandem master brake cylinder, comprising a cylindrical pressure housing with a primary pressure chamber and a secondary pressure chamber definable by a primary piston with a central valve and a secondary piston with a central valve, wherein an additional 2/2-way hydraulic valve is operatively arranged on or in the secondary pressure chamber and is mechanically operatively connected with the secondary piston.

44. The tandem master brake cylinder as claimed in claim 43, wherein the 2/2-way hydraulic valve contains a resetting spring.

45. A method for activating an electrohydraulic brake system having a hydraulic control unit for at least two brake circuits, at least two cut valves, an electronic control unit, one of a pressure supply and at least one pressure accumulator, a plurality of sensors for determining a brake application intention, and an actuating unit comprising a brake pedal, a tandem master brake cylinder and a pedal travel simulator, comprising varying the hydraulic pressure in a return line of the pedal travel simulator by way of hydraulic valves.

46. The method as claimed in claim 45, further comprising activating at least one hydraulic valve in the hydraulic line between the pedal travel simulator and intake side of the pressure supply, brake fluid reservoir or return line of the hydraulic control unit by the control unit with a linear or nonlinear pedal-travel/pedal-force characteristic curve.

47. The method as claimed in claim 46, wherein, with the nonlinear pedal-travel/pedal-force characteristic curve, the pedal force rises super-proportionally, one of progressively or exponentially, with increasing pedal travel.

48. The method as claimed in claim 45, further comprising, in the event of a component of the electro-hydraulic brake system becoming defective or if the control unit fails, and upon actuation of the brake pedal, hydraulically connecting the return-side hydraulic connection of the pedal travel simulator to a delivery side of the pressure supply or to the at least one pressure accumulator.

49. The method as claimed in claim 48, further comprising feeding back brake fluid situated in the pedal travel simulator is fed back into an auxiliary brake circuit.
